(19) United States
(12) Patent Application Publication
(10) Pub. No.: US 2016/0053615 A1
(43) Pub. Date: Feb. 25, 2016

(54) METHOD FOR RESTORING A COVER PLATE PRETENSION

(71) Applicant: SIEMENS AKTIENGESELLSCHAFT, München (DE)

(72) Inventors: Yevgen Kostenko, Ratingen (DE); Andreas Ulma, Mulheim an der Ruhr (DE)

(73) Assignee: Siemens Aktiengesellschaft, Munich (DE)

(21) Appl. No.: 14/784,130

(22) PCT Filed: Apr. 4, 2014
(86) PCT No.: PCT/EP2014/056813

§ 371 Date: Oct. 13, 2015

(30) Foreign Application Priority Data
Apr. 17, 2013 (EP) 13164028.6

(51) Int. Cl. F01D 5/00; F01D 9/04

(52) U.S. Cl. CPC F01D 5/005; F01D 9/041; F05D 2220/31; F05D 2230/232; F05D 2230/80

(57) ABSTRACT

A method for repairing a blade row, wherein the blades have cover plates and a disruptive gap has occurred between the cover plates, wherein in a first method step, a bracing element is arranged in the gap between the cover plates and, in a second method step, the element and the plates are welded together.

### CROSS REFERENCE TO RELATED APPLICATIONS

This application is the US National Stage of International Application No. PCT/EP2014/056813 filed Apr. 4, 2014, and claims the benefit thereof. The International Application claims the benefit of European Application No. EP13164028 filed Apr. 17, 2013. All of the applications are incorporated by reference herein in their entirety.

### FIELD OF INVENTION

The invention relates to a method for restoring a cover plate pretension of turbine blading, wherein the blades or vanes are formed with cover plates, and wherein a gap has formed between two cover plates of adjacent blades or vanes on account of damage.

### BACKGROUND OF INVENTION

In turbomachines, for example steam turbines, a flow medium is moved between what are referred to as guide vanes and rotor blades. The rotor blades are arranged on the surface of a rotor, the rotor being mounted rotatably about an axis of rotation. The individual rotor blades are configured so as to form what is termed a rotor blade row, that is to say that the individual rotor blades are arranged in the circumferential direction on the rotor surface.

The rotor is arranged together with the rotor blade rows, which are arranged in succession in a direction of flow, in a housing, the guide vanes being arranged on an inner face of the housing. Here, the guide vanes are arranged in such a manner that they are likewise arranged in succession in a circumferential direction and thus form a guide vane row. A flow duct, through which the flow medium flows, is thus formed between the guide vane rows and the rotor blade rows. In the case of a steam turbine as an example of a turbomachine, steam flows as the flow medium along the flow duct.

The movement of the flow medium in the flow duct causes the rotor to rotate. This rotation can be utilized, for example, to drive electric generators.

The rotor blades have an aerodynamic profile, the rotor blades having what are termed cover plates on the ends as seen from the axis of rotation. These cover plates are arranged on the ends of the rotor blades and thus form a delimitation for the flow duct. During the operation of a turbomachine formed in this way, there may be instances of contact between the individual shrouds of the rotor blade rows and the opposing sealing bands in the housing, or in the case of guide vanes the opposing rotor, and these lead to a high level of loading on the material. This can lead to undesirable damage on the shrouds. A case of damage would be, for example, the formation of a gap between the individual cover plates, which could lead to disruptive vibrations of the blades or vanes during operation.

Such aforementioned gaps can form as a result of instances of plasticization on the guide vanes or rotor blades.

In order to prevent further damage, damaged rotor blades or guide vanes would have to be replaced, but this would involve a high level of expenditure and is carried out only during planned maintenance. Such a replacement can naturally also be carried out only when an appropriate supply of replacement blades or vanes is available.

A further possible way to counter such damage is to document the finding and delay the final repair until subsequent maintenance. However, this increases the operational risk on account of possible tearing of the blades or vanes. A further scenario would be one in which the overall blade or vane assembly is at risk as a whole from a defective gap.

### SUMMARY OF INVENTION

The invention aims to provide a remedy here.

It is therefore an object of the invention to specify a method which is used in the case of blades or vanes with shrouds, wherein a gap is formed between two cover plates on account of damage and a further advance of the damage is avoided.

This object is achieved by a method for restoring a cover plate pretension of turbine blading, wherein the blades or vanes are formed with cover plates, wherein a gap has formed between two cover plates of adjacent blades or vanes on account of damage, said method comprising the following steps:—inserting a bracing element into the gap,—welding the bracing element to the shroud.

The bracing element is formed with a wedge piece, the wedge piece being wedge-shaped and being arranged in the gap. The bracing element thus has a wedge piece which protrudes into the gap and has a wedge-shaped form. This particular shape of the wedge piece can exert a force between two shrouds, and therefore it is possible to restore a pretension in the shrouds. In other words, the blade or vane row, the cover plates of which represent a shroud assembly, can be formed in such a way again that a pretension is formed.

It is therefore proposed according to aspects of the invention to arrange an additional component, specifically a bracing element, between the cover plates, in order to thereby counter the costly replacement of a blade or vane. This bracing element is introduced into the gap from an inner side of the blade or vane row and welded from the inside or from the outside.

The advantage of this method according to aspects of the invention lies in the fact that the blade or vane row can be braced again. Such bracing of the blade or vane row until the next inspection is thus ensured at low cost. A reliable use of the turbine thereby avoids possible damage and further damage to the blade or vane row can be avoided as a result. The blade or vane row forms a blade or vane assembly. The blade or vane assembly is thereby protected from the occurrence of further damage.

Advantageous developments are specified in the dependent claims.

In a further advantageous development, the bracing element has a T-shaped form and the wedge piece is arranged perpendicular to the crossbar.

This T-shaped form facilitates the insertion of the bracing element into the defective gap. Furthermore, movement of the bracing element between the shrouds is effectively avoided on account of forces, e.g. centrifugal forces.

Advantageously, the bracing element is thereby arranged in such a manner that the crossbar lies beneath the shrouds. This means that the crossbar is arranged in the flow duct. Therefore, the crossbar should not have an unnecessarily large form.

In a further advantageous development, the insertion of the bracing element exerts a force between the shrouds, which leads to the shrouds being pressed apart. A pretension in the shroud assembly or in the blade or vane assembly is possible again as a result.

The above-described properties, features and advantages of this invention and the manner in which they are achieved become more clearly and distinctly comprehensible in conjunction with the following description of the exemplary embodiments which are explained in more detail in connection with the drawings.

Exemplary embodiments of the invention will be described hereinbelow with reference to the drawings. This is not to definitively show the exemplary embodiments, but rather the drawing, where conducive to clarification, is constructed in a schematized and/or slightly distorted form. With regard to additions to the teaching which is directly apparent in the drawing, reference is made to the relevant prior art.

### BRIEF DESCRIPTION OF THE DRAWINGS

In the drawing:

FIG. 1 shows a plan view of two shrouds;

FIG. 2 shows a cross-sectional view of part of a blade or vane row;

FIG. 3 shows a perspective view of part of a blade or vane row;

FIG. 4 shows a perspective view of part of a blade or vane row.

### DETAILED DESCRIPTION OF INVENTION

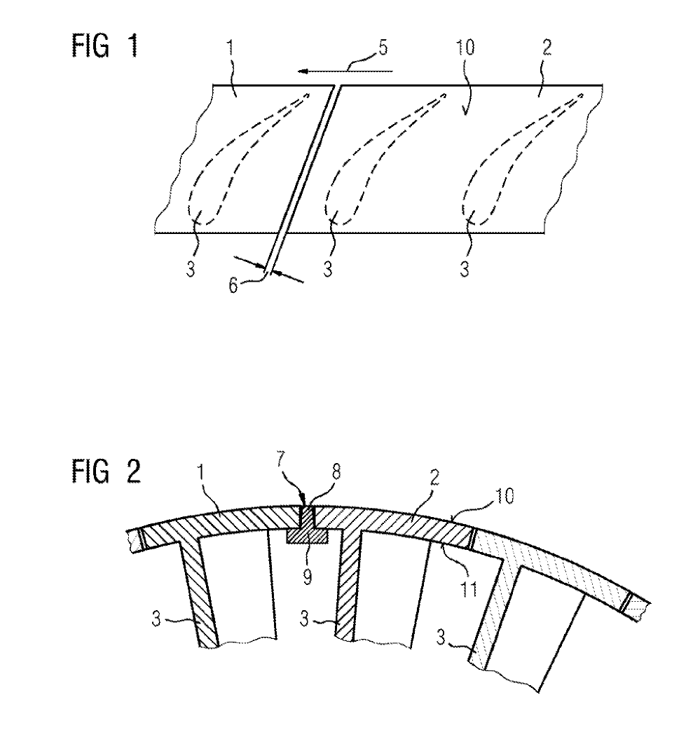

FIG. 1 shows a plan view of a first cover plate 1 and a second cover plate 2. The first cover plate 1 and the second cover plate 2 are arranged on the ends of blade or vane profiles 3. In FIG. 1, the blade or vane profile 3 is represented by dashed lines. The first cover plate 1 and the second cover plate 2 form a blade or vane in each case with the blade or vane profile 3 and a blade or vane root 4. In the case of guide vanes, the vane root is arranged in a housing. In the case of rotor blades, the blade root 4 is arranged on a rotor. The invention can be used both for guide vanes and for rotor blades. The first cover plate 1 and the second cover plate 2 are arranged in a circumferential direction 5. A gap 6, which can be referred to as damage, can form between the first cover plate 1 and the second cover plate 2. The blades or vanes form a successive arrangement of a blade or vane row in the circumferential direction 5. In FIG. 1, the gap 6 has formed between the first cover plate 1 and the second cover plate 2 of two adjacent blades or vanes on account of damage. The method for repairing the blade or vane row then provides for a bracing element 7 to be inserted into the gap 6 in a first step. In a second step, the bracing element is welded to the cover plates 1, 2.

This weld can be made beneath, outside or at the ends of the first cover plate 1 and second cover plate 2, and also outside the first cover plate 1 and the second cover plate 2.

The cover plates 1, 2 form a shroud when arranged circumferentially in an assembly.

The bracing element 7 is formed with a wedge piece 8, which is wedge-shaped and is arranged in the gap 3. The wedge piece 8 has a wedge-shaped form here in such a manner that movement of the wedge piece 8 in the direction of the first cover plate 1 or the second cover plate 2 exerts a force which leads to the first cover plate 1 and second cover plate 2 being pressed apart.

The bracing element 7 has a T-shaped form, the wedge piece 8 being arranged perpendicularly on the crossbar 9. The crossbar 9 is thus arranged on the inner side of the first cover plate 1 and second cover plate 2.

The insertion of the bracing element 7 generates a force between the first cover plate 1 and second cover plate 2 which leads to the first cover plate 1 and second cover plate 2 being pressed apart.

FIG. 2 shows a sectional illustration of part of the blade or vane row. In this figure, the bracing element 7 is shown in the installed state, i.e. after the repair method according to aspects of the invention. The bracing element 7 is welded to the first cover plate 1 and to the second cover plate 2. This weld can be made on the shroud surface 10 or on the inner shroud face 11.

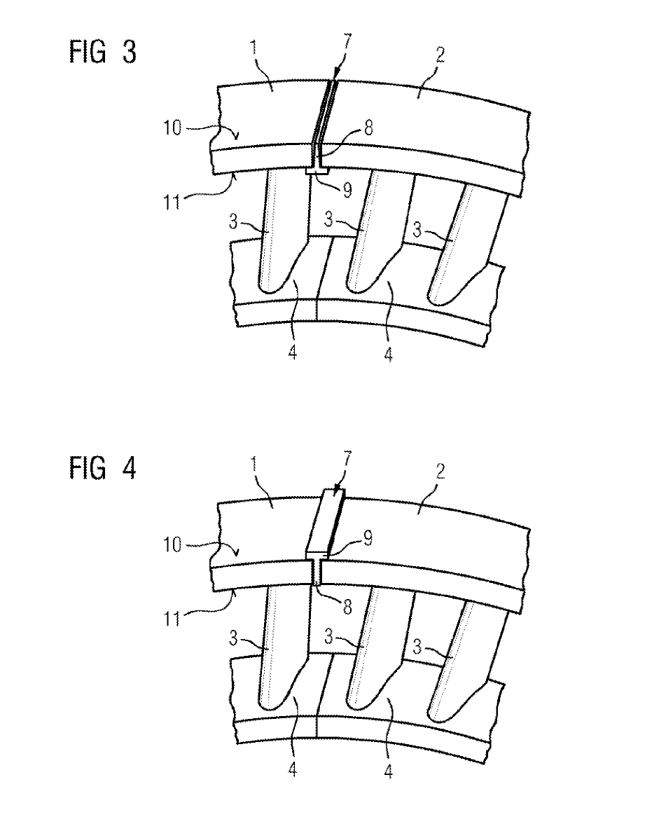

FIG. 3 shows a perspective view of the blade or vane row. For reasons of clarity, merely one bracing element 7 has been shown in the figures. The method according to aspects of the invention for repairing the blade or vane row makes it possible by all means to arrange a plurality of bracing elements 7 between two adjacent cover plates.

FIG. 4 shows an alternative embodiment of the bracing element 7. In contrast to FIG. 3, the bracing element 7 is configured in a manner turned approximately through 180°. This means that the crossbar 9 is arranged above the cover plate 2. The wedge piece 8 thus lies between two cover plates 2. The wedge piece does not have to have a wedge-shaped form, however. Instead, the wedge piece 8 can be formed substantially parallel to the contact surfaces of the cover plate 2. In order that the bracing element 7 does not break away from the shroud during operation, it is welded to the cover plates 2.

The invention can be used in steam turbines.

Although the invention has been described and illustrated in more detail by way of the preferred exemplary embodiment, the invention is not restricted by the disclosed examples and other variations can be derived herefrom by a person skilled in the art without departing from the scope of protection of the invention.

1. A method for restoring a cover plate pretension of turbine blading, wherein the blades or vanes are formed with cover plates, wherein a gap has formed between two cover plates of adjacent blades or vanes on account of damage, said method comprising the following steps:
inserting a bracing element into the gap,
welding the bracing element to the cover plate,
wherein the bracing element is formed with a wedge piece, which is wedge-shaped and is arranged in the gap.

2. The method as claimed in claim 1,
wherein the bracing element has a T-shaped form and the wedge piece is arranged perpendicular to the crossbar.

3. The method as claimed in claim 2,
wherein the bracing element is arranged in such a manner that the crossbar lies beneath the cover plates.

4. The method as claimed in claim 1,
wherein the insertion of the bracing element generates a force between the cover plates, which leads to the cover plates being pressed apart.
